(19) United States
(12) Patent Application Publication
(10) Pub. No.: US 2025/0012601 A1
(43) Pub. Date: Jan. 9, 2025

(54) GEOLOCATION PROCESS AND SYSTEM

(71) Applicant: Nicholas Robinson, Lewes (GB)

(72) Inventor: Nicholas Robinson, Lewes (GB)

(73) Assignee: Xipcode, Ltd, Lewes (GB)

(21) Appl. No.: 18/226,415

(22) Filed: Jul. 26, 2023

Related U.S. Application Data
(60) Provisional application No. 63/524,921, filed on Jul. 5, 2023.

(51) Int. Cl. G01C 21/00

(52) U.S. Cl. CPC G01C 21/3859; G01C 21/3874

(57) ABSTRACT

The present invention includes a system and process that supplies geographic information to a user based on parsing a virtual land domain into a myriad of virtual nodes extending from a center of plot points of a space-filling curve occupying the virtual land domain. Pathway instructions can be supplied from a starting point virtual node to a target virtual node. The system can supply a pathway estimation based on whether the virtual nodes include attribute tags, particularly, the attributes of “obstruction” and “entryway” or substantially similar attributes.

### FIELD OF THE INVENTION

The present invention relates to the field of electronic maps and more specifically to the field of multimedia-based applications utilizing geolocation.

### BACKGROUND

For many people, inaccurate locations is just a fact of life. Billions of people use satellite navigation apps to travel—and for the most part they are acceptable. However, they do not take you to the right place, but nonetheless insist that “you have reached your destination.”

The three main reasons for the epidemic of location inaccuracies are firstly: the use of Zip Codes/post codes, which are systems designed for postal services, individual postcode and Zip Code areas can be several square miles; secondly, plain old map inaccuracies—in particular, those in GOOGLE Maps, of which there are very many; thirdly, a complex aggregation of other general inaccuracies, brought about by data entry errors, mistaken identities and so on.

The present invention produces links that are considerably more feature rich than, say, simply sending a link extracted from GOOGLE Maps. Locations can be finely adjusted—or indeed, moved to the other side of the planet—while the link of the present invention—which may have been widely shared or publicized does not change, but rather points to the new location.

### SUMMARY

The present invention includes a graphic user interface which allows users to fine tune and adjust the accuracy of locations using a number of different methods. This is key to achieving optimum location accuracy. Individuals can save and organize their locations in the system using folders and tabs. For example, a user may place all work locations into one folder, personal places into a second and holiday locations into another. Tabs, which can be searched, offer a further level of organization. The present invention also features a system for making packs of locations available. Examples include all the locations where the popular television series GAME OF THRONES was filmed, where public defibrillators are located in a specific town, the locations of disabled parking spaces, and so on.

The present invention features a system and process for geolocation. The process includes rendering in a master computer a digital representation of a geographic region as a virtual land domain. Then the virtual land domain is parsed said into a myriad of parcel geometric forms characterized by a decimal representation comprising at least six decimal places adapted to define the virtual land as surface area having a square root no greater than an average shoe size for the geographic region. A request for the parcel geometric form, i.e., virtual node, is broadcast through a Wide Area Network (WAN to a mobile computing device of a user querying a location within the geographic region. The accuracy of the location for the virtual node can be verified by the user in the alleged physical location of the virtual node.

The present invention can functionally label virtual nodes such that discrete land spaces can be searched based on their function rather than necessarily their location. These reverse searches can return data from discrete land spaces matched the searched function. Media files can be associated with the virtual nodes for various purposes.

When media is applied to links within the system, the media can be routed through an intermediate link, so that when the location changes, the system can apply the change to the new location. This is a particularly handy feature for the commercial system, which promotes efficient advertising for users and the commercial entities. Reverse searching allows similarly situated entities to entice users in their direction with solicitations, coupons, media, and other forms of persuasion.

A location link, i.e., virtual node can be created in several ways. A simple press of a button saves the location that a user currently occupies. Once this is done, the system stores locations in decimal degrees to six decimal places, which (at the equator), is a square measuring 11.1 centimeters. An area smaller than that which a standing person occupies.

Decimal degrees are an alternative the sexagesimal degrees (degrees, minutes, and seconds or DMS) notation and are used by the majority of electronic maps, sat-nav systems and geographical information systems.

Plenty of systems still use DMS values, which, it is worth noting, can be calculated directly from decimal degrees. Aside from this, the system also generates a unique serial number, a Geohash, which stores the latitude and longitude, and the date & time that the location was captured. Photos, video and text can also be added at the time or later on.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a view of a virtual representation of the parsing of the present invention of a virtual land domain into virtual nodes.

FIG. 2 is a view of the computer ecosystem and processes of the present invention.

FIG. 3 is a view of the computer ecosystem and processes of the present invention.

FIG. 4 is a view of the computer ecosystem and processes of the present invention.

FIG. 5 is a view of an entity representation of the present invention.

FIG. 6 is a view of an entity representation of the present invention having been mapped with the virtual nodes representing discrete physical land spaces.

FIG. 7 is a view of the computer ecosystem and processes of the present invention.

FIG. 8 is a view of the computer ecosystem and processes of the present invention.

FIG. 9 is a view of an entity representation of the present invention.

FIG. 10 is a view of an entity representation of the present invention.

FIG. 11 is a representation of the parsing of the present invention.

FIG. 12 is a representation of the parsing of the present invention.

FIG. 13 is a representation of the parsing of the present invention with six digit representations.

FIG. 14 is a representation of the parsing of the present invention with six digit representations virtually overlayed over a geographic entity.

FIG. 15A is a view of the computer ecosystem of the present invention.

FIG. 15B is a view of the computer ecosystem of the present invention.

FIG. 16 is a view of the computer ecosystem of the present invention.

FIG. 17 is a view of the parcel geometric form.

FIG. 18 is a view of the system data.

FIG. 19 is a view of the computer ecosystem of the present invention.

FIG. 20 is a view of the computer ecosystem of the present invention.

FIG. 21 is a view of the computer ecosystem of the present invention.

### DETAILED DESCRIPTION

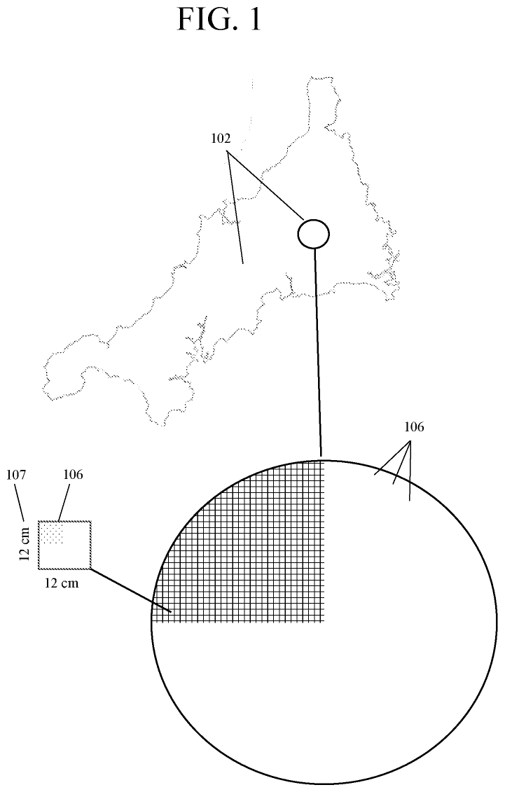

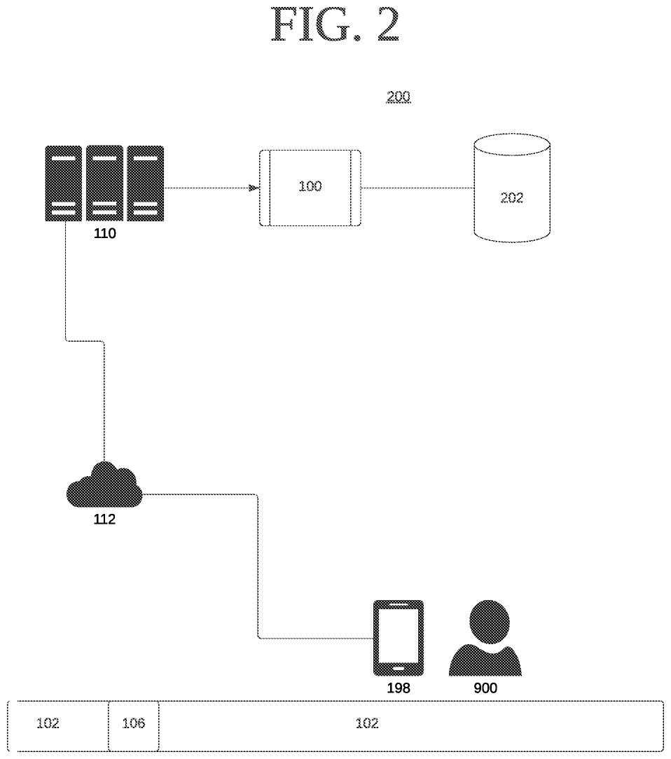

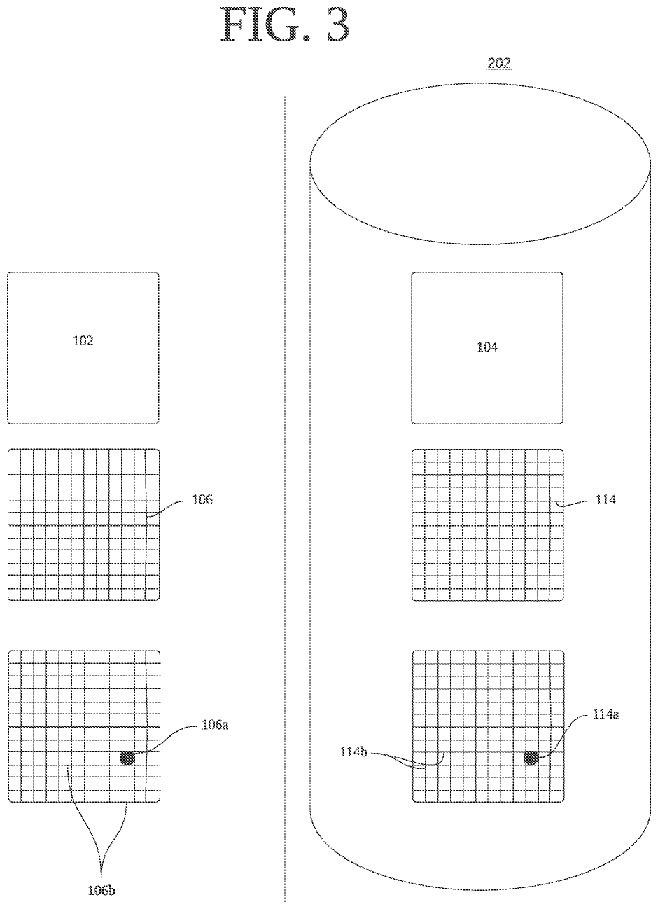

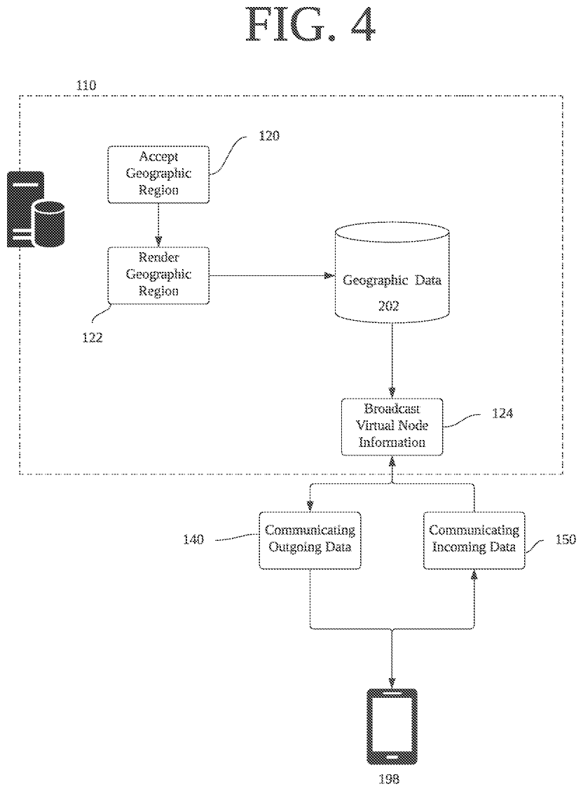

The present invention includes an electronic location process 100 and system 200 intended to be used as a map system. Turning now to FIGS. 1-2, the present invention takes 120 the existence of a natural, physical land geographic region 102 and converts the geographic region into a virtual land domain 104. In view of FIGS. 3-4, the spaces of the present invention will be discussed in two different categories, those with are physical and those representations of the physical land in computer storage.

The present invention is capable of use with any geographic region 102, whether or not it is standardized. The geographic region 102 can include any world, country or subdivision thereof (e.g., state, province, city, parks, etc.), physical feature (e.g., mountain, ocean, lake, river, etc.), construction of mankind (e.g., buildings, ships, shopping centers, etc.), or other thing that would be helpful to be conceptually divided into different parts. FIG. 1 displays the land region 102 Cornwall, United Kingdom. Cornwall, like any roughly two-dimensional object, can be subdivided into subdivisions, and according to the present invention, this can be discussed as one or more discrete land spaces 106. The discrete land space 106 can be any size useful to be discussed. The present invention parses 122 the geographic region in a myriad of discrete land spaces based a suitable algorithm. It should be noted that the size of discrete land space matters in particular ways. If the discrete land space 106 is excessively large, then citation of the land space will be of less utility to a user; if too small, then parsing 122 and later steps of the present invention will be computationally heavy and also strain the credibility of the system to accurately discern the location of the discrete land. There is a fine line between computational efficiency, credible location analysis, and helpfulness. The present invention seeks a happy medium between computational weight and utility.

The present invention's utility is partly contained in its unorthodox use of decimal degrees location calculations rather than sexagesimal degrees. Decimal degrees can be used as an alternative the sexagesimal degrees (degrees, minutes, and seconds (or DMS)) notation and can be used by electronic maps, satellite navigation systems, and geographical information systems. For purposes of the present invention, the system and process characterizes land divisions 106 as discrete land spaces utilizing six decimal places. The particular methodology results in discrete land space 106 subdivisions that occupy a square with sides measuring approximately 11.1 cm. For each physical subdivision, there exists a virtual version of it stored in a master computer 110. With particular reference to FIG. 3, the virtual version of the geographic region 102 is the virtual land domain 104. The virtual version of the discrete land mass 106 is the parcel geometric form 114 (or “virtual node,” and these terms may be used interchangeably in this disclosure). The reason that this virtual node 114 can be considered as a parcel geometric form is because the virtual nodes will comprise a series of neighboring spaces that when aggregated form the virtual land domain 104. In the same way in which a tile floor can be an aggregation of squares, rectangles, hexagons, etc., so too can the present invention utilize a variety of shapes. However, the preferred parcel geometric form is a square with less than 12 cm sides.

The significance of the size of the virtual node 114 is that it comprises a land space in which only one human can possibly occupy at any one moment. The size of the parcel can vary for particular geographic regions. The concept of feet/shoe size can figure prominently with the particular invention because it is a good marker of the extent to which multiple humans can occupy a single space. This information is widely available and an example of such information can be found here: https://fitnessgraft.com/average-foot-size-men-women/.

TABLE 1
Average Shoe Size

| | | |
|---|---|---|
| Country | Male | Female |

| | | | | |
|---|---|---|---|---|
| United States | Size 9 | (43) | Size 7 | (39) |
| Canada | Size 10 | (43.5) | Size 6.5 | (38.5) |
| United Kingdom | Size 9 ½ | (43) | Size 7 | (39) |
| China | Size 8 | (41) | Size 5 ½ | (37.5) |

As, for example, Chinese feet tend to be smaller than Canadian feet, it might be appropriate to fashion a virtual node in Canadian maps larger than Chinese maps, both physical and virtual. Furthermore, the size of feet can be approximated based on anecdotal evidence.

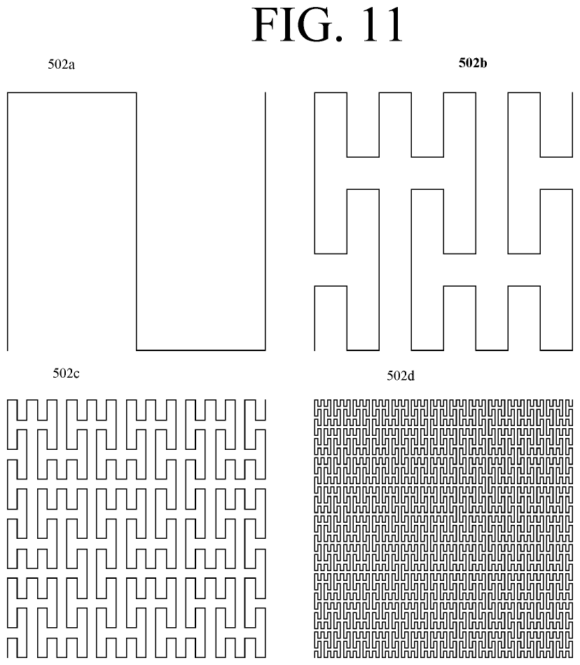

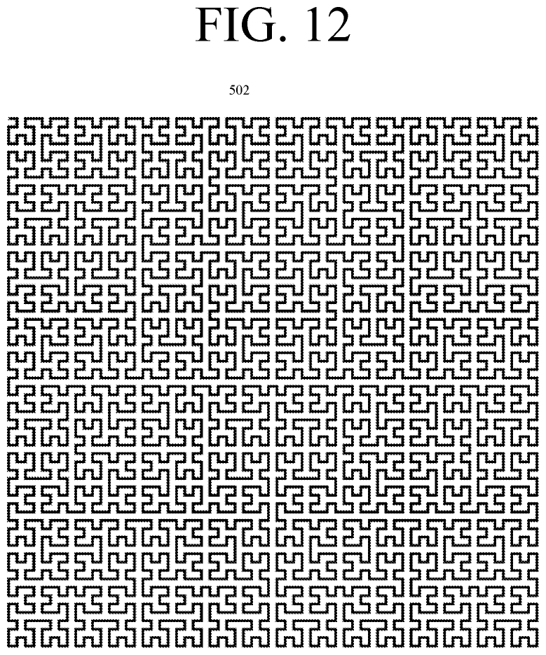

The present invention avoids the direct use of latitude and longitude as conventionally used. The present invention utilizes geohashing as at least an intermediate value. Geohashing is a hierarchical spatial data structure which subdivides space into buckets of grid shape, which is one of the many applications of what is known as a Z-order curve, and generally space-filling curves. In mathematical analysis, a space-filling curve is a curve whose range contains the entire two-dimensional unit square (or more generally an n-dimensional unit hypercube). In the most general form, the range of such a space-filling function may lie in an arbitrary topological space, but in the most commonly studied cases, the range will lie in a Euclidean space such as the two-dimensional plane (a planar curve) or the 3-dimensional space (space curve). Space-filling curves are special cases of fractal curves. As can be shown in FIG. 11, a space-filling curve 502a-d, here a Peano curve, acquires higher granularity based on the order of the curve. A Peano curve is a version of what is known as a “reverse N” curve that takes is name from the rough path of the curve. A Hilbert curve is an iteration of what is know as a “Z curve,” again a rough estimation of the path of the curve, that is generally considered to be a simpler implementation of a space filling curve that acquires higher-granularity based on the order of the curve. Here, FIG. 11 includes a series of space filling curves, of increasing order from 502a-502d, respectively. A relatively high order space filling curve, here a Hilbert curve, is shown in FIG. 12.

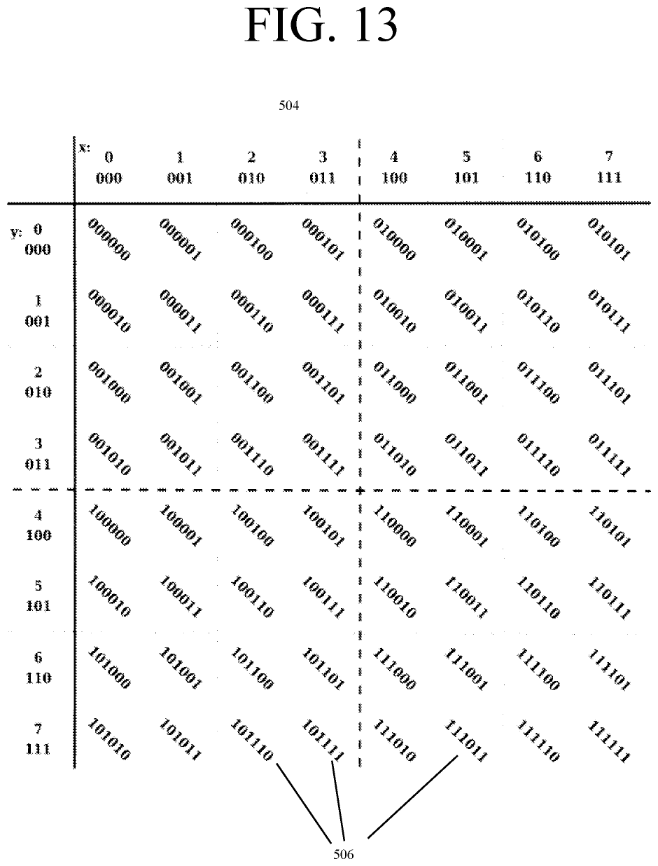

FIG. 13 shows the Z-values for the two dimensional case with integer coordinates 0≤x≤ 7, 0≤y≤7 (shown both in decimal and binary). The curves are a result of granular interpolation of date to form a curve that are shown in FIGS. 11-12. Interleaving the binary coordinate values (starting to the right with the x-bit (even positions) and alternating to the left with the y-bit (odd positions) yields the binary z-values. Connecting the z-values in their numerical order produces the recursively Z-shaped curve. The Z-ordering can be used to efficiently build a quadtree (two-dimensional) or octree (three-dimensional) for a set of points. The basic idea is to sort the input set according to Z-order. Once sorted, the points can either be stored in a binary search tree and used directly, which is called a linear quadtree, or they can be used to build a pointer based quadtree.

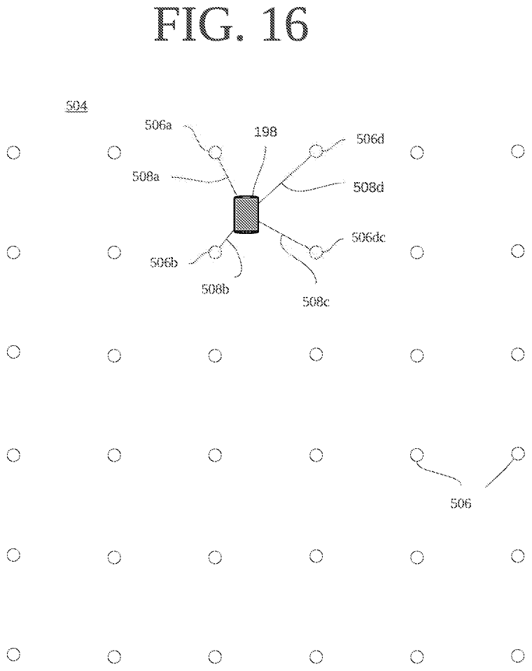

In view of FIG. 16, the plot points 506 of the space-filling curve (curve not shown) serve as anchor points of the virtual nodes 114 in a virtual plot-map 504. Again, the virtual node 114 forms the extents of distance in which an object would be considered to be closest to that plot point 506. As shown, an object 198, here a telephone, is positioned within a physical land mass overwhich is laid the virtual space-filling curve composed of its plot points 506. The location of the object would ensure that it is near multiple plot points 506a-d, wherein the system would perform a calculation that maps 150 the location of the object, no in its precise location, but rather an estimation based on the nearest plot point 506. Here plot points 506a, 506b, 506c, and 506d are in contention for the location nearest the object 198. Here, the relative distances form the object to the curve points 506 are 508a, 508b, 508c, 508d, respectively. As can be reasonably seen, the object 198 is nearest to plot point 508b. Accordingly, the virtual node 114 that constitutes the geometric virtual space around 506b would constitute the node 114 associated with the position of the object 198, rather than its true location. Therefore, the present invention loses something in precision, but gains significantly in efficiency in storage, calculation, reasonableness of association, and the like.

To obtain a geohash, the user provides an address to be geocoded, or latitude and longitude coordinates, in a single input box (most commonly used formats for latitude and longitude pairs are accepted), and performs the request. Besides showing the latitude and longitude corresponding to the given geohash, users who navigate a geohash can also presented with an embedded map, and may download a GPX file, or transfer the waypoint directly to certain GPS receivers. Links are also provided to external sites that may provide further details around the specified location. Essentially, a space-filling curve such as that of FIG. 13 is conceptually overlaid over a representation of an area 104, such as the state of Indiana, resulting in a space filling curve that can identify a location within two-dimensional area based on a single number that is bifurcated into x-values and y-values that can derive from and/or result in latitude and longitude coordinates.

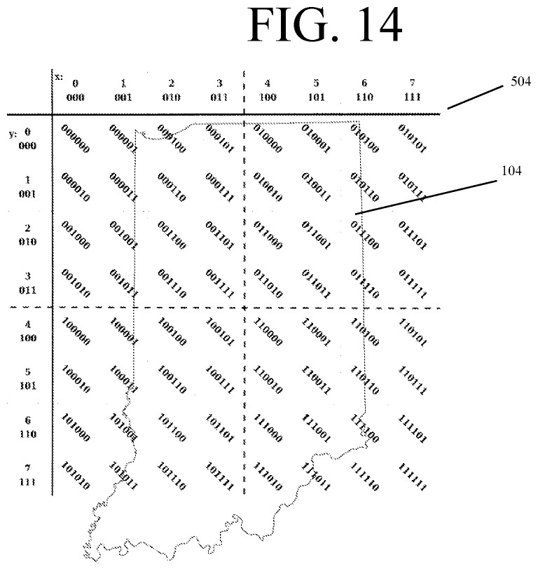

The coordinates of the geohash result in the center point of a rectangle corresponding to the node of the present invention. As can be seen, as higher-order values are used in the calculation of the present invention, these rectangular areas become smaller. If one were to estimate the approximate location based on the overlaid map of FIG. 14, essentially one could have a level of accuracy of approximately +/−10 miles (because each rectangle includes a side of approximately 20 miles).

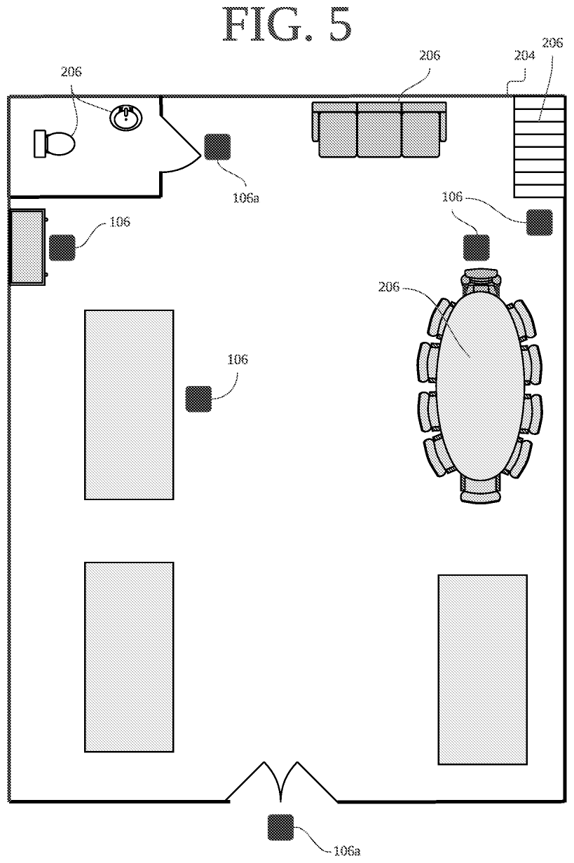

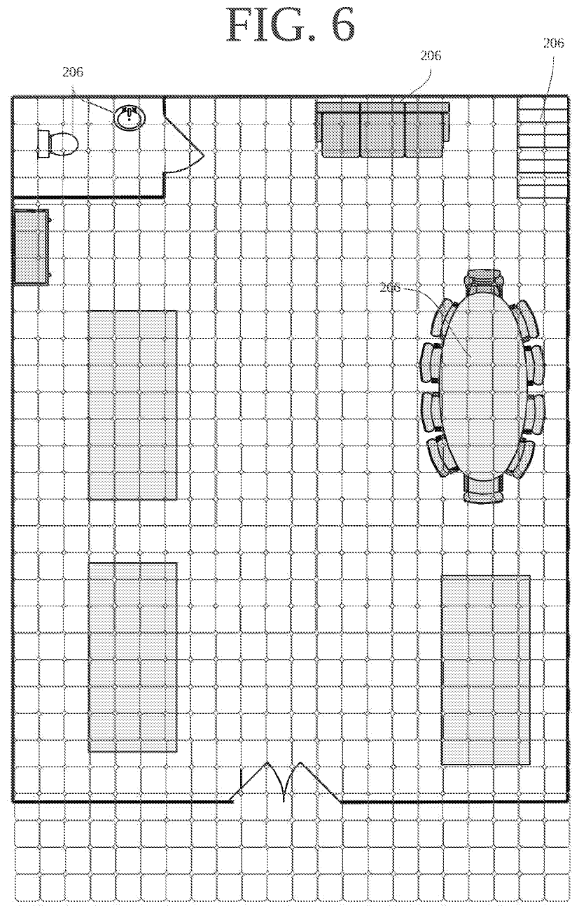

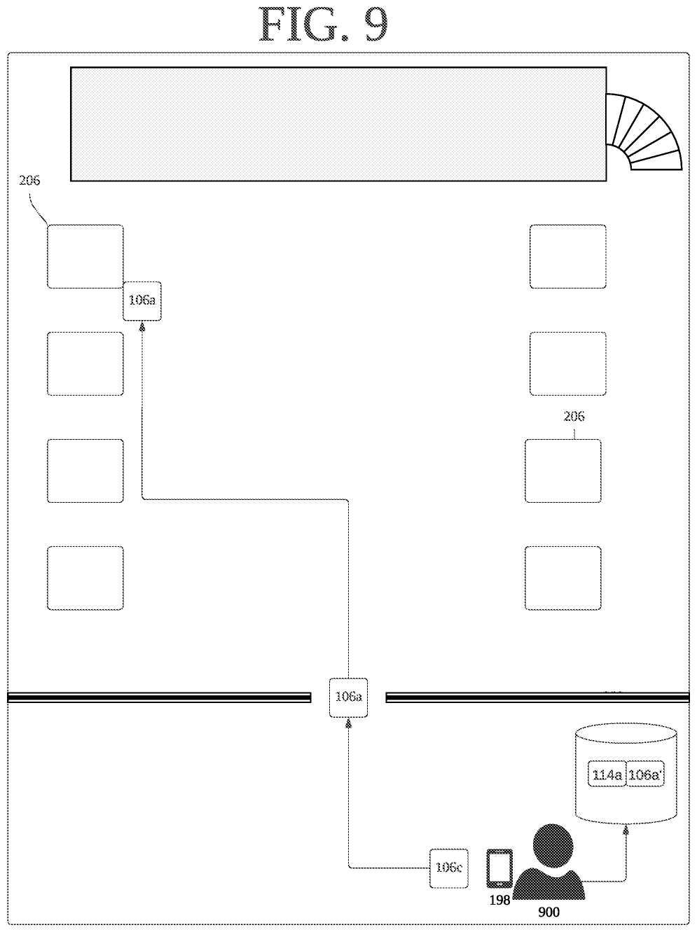

Turning now FIG. 5, the present invention demonstrates the physical space representation of the virtual nodes that can be stored in the system 200. Supposing that FIG. 5 represents something like an office building, the geographic region can be subdivided into a series of discrete land spaces. To scale, the present space might includes around eight-hundred discrete land spaces. The present invention could have subdivided these spaces from an initial point prior, as shown in FIGS. 6 and 9, to a single visit by a user of the present invention, or the discrete land spaces 206 can be identified ‘as-required’ by the system and users. Here we have only mapped out the discrete land spaces 206, 106a that are identified as ‘functional’ or utilized by the system. Returning to FIG. 5, a series of discrete land spaces 106 have been marked by the present invention, meaning that these discrete land spaces are correlated in the system data 202 to one or more virtual nodes (not shown).

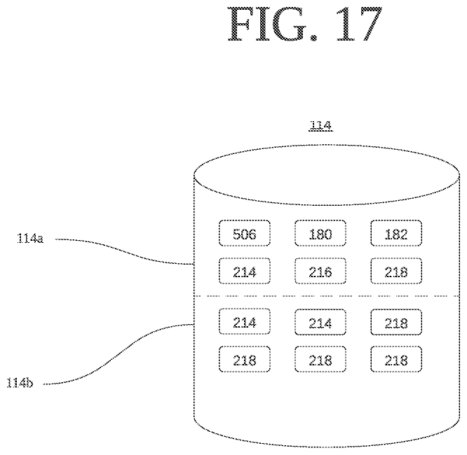

A user attempting to use a mobile computer to acquire course data to a location might seek a virtual node using the system of the present invention. A user exterior to the entity building, perhaps while at home, may go a website that publicizes the building and from that website could make a request over a client-server for ‘course data’ to the entity. Course data, under the present invention, include one or more pathway 212 instructions from an origin to an end point, an origin to one or more intermediary points and then to an endpoint, directly to an end point, or to one or more intermediary points to an end point. Generally speaking the end point will be the discrete land space 106 that correlates with the virtual node. Accordingly, under the present invention rather than simply provided a generalized DMS instruction to a large area thought to be the entity, but rather a user can be taken to the entry point of the building. Furthermore, by sequencing the pathway instruction to go through multiple discrete land spaces 106, the present invention can further provide an turn-by-turn exact pathway course to a destination. And now, the destination need not simply be identified by the entity, but rather the features and functions possessed by the entity. Continuing the example of FIG. 5, a user simply seeking a course pathway to the entity 204 will receive virtual node data corresponding to the target virtual node correlated with the discrete land space 106a in front of the door (lower space in figure)). Entity attributes may further include such information related to the pathway estimation attributes 216 such as “obstruction” as a true or false. The pathway estimation attributes may further include information as “entryway” or “desk” or other more specific instruction concerning the passability of the object, for example, whether such an obstruction is conventionally so or capable of being a throughway in the event of an emergency, e.g. a window (as shown in FIG. 17). The existence of an obstruction may be applied to the pathway estimation shown in FIG. 9.

Furthermore, because the system and process can now allow a user to seek instructions based not merely on the 204, but features and functions 206, within the entity 204. For example, there may an incoming 150 user query to the system that asks the system for a functional attribute, irrespective of the entity that may house the functional attribute. An example may include the search for a bathroom. Continuing in the discussion of FIG. 5, two virtual nodes may be of consequence related to discrete land spaces 106a and have functional attributes. The two labeled discrete land spaces 106a of FIG. 5 include an “entryway” and “bathroom” (or more specifically, the entryway to the bathroom. These become target virtual nodes for target discrete land spaces 106a that are helpful to the user in reaching his final goal of a bathroom. A user that seeks a bathroom may not necessarily be concerned with the entity that houses the bathroom—although in certain circumstances the entity may matter very much. However, a user incoming query 150 that requests “bathrooms” can receive a list of bathrooms and their relative distance from the discrete land space that the user is presently occupying. If the user selects the bathroom 206 of FIG. 5, then the process can first lead the user to the target discrete land space 106a entryway and then to the target discrete land space 106a in front of the bathroom door.

The discrete land spaces 106 within an entity can be numerous and varied. As shown in FIG. 5, the present invention can include feature-based discrete land spaces 106, 106a that can include a cabinet, a bathroom, a stairwell, a table, a conference room, or even a particular seat at a table. Under the present invention, one can even indicate a specific seat in a movie theater as a virtual node corresponding to a discrete land space.

### Example 1

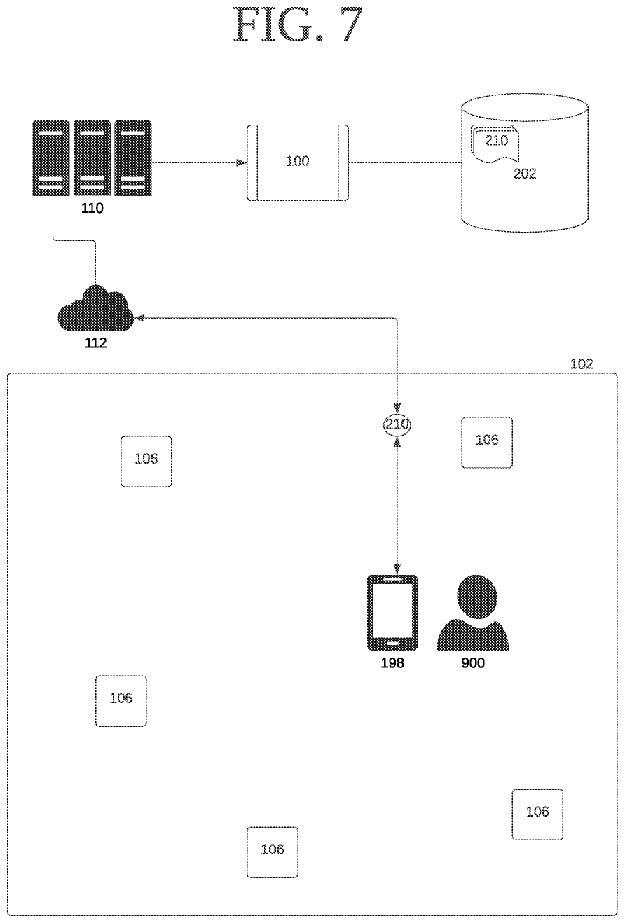

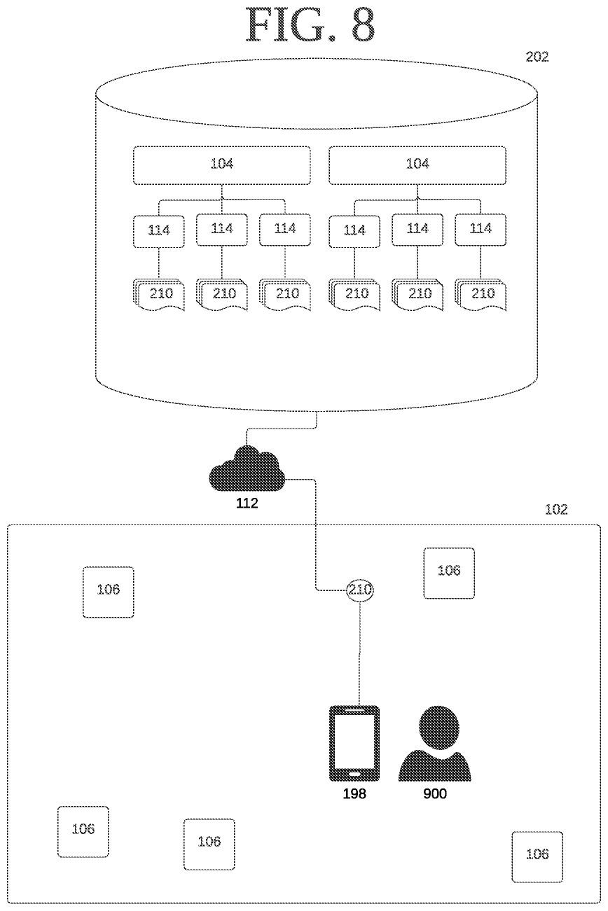

Turning now to FIGS. 7-8, the present invention can now permit users 900 to see, store, and review data, particularly media 210, not only based on an entity but the features within the entity. This allows a user to review media 210 concerning a discrete land space 106 that has been submitted by the entity itself or an agent of the entity or other third-party users. For example, a user 900 seeking a soda vending machine can run a search for the functional attribute, which can serve as a functional attribute ‘tag,’ related to the function that it seeks. Accordingly, the virtual nodes 114 in the area proximate to the user 900 corresponding to discrete land spaces 106 known to the system in the region 102 can be searched. A list of virtual nodes 114 corresponding to the discrete land spaces 106 can be provided to the user 900. However, the present invention can allow a search based on more than simply the functional tag. In addition, media files 210 associated with the virtual nodes 114, and perhaps even further winnowed to the function associated with the virtual node in instances wherein a discrete land space 106 can include multiple functions, and provided 150 to the user 900. Not only can a user 900 differentiate soda machines 206 of interest based on course pathway and distance, but also based on the images of the soda machines, which may inform the user as to which machines are old, are in poor shape, lack certain products, etc. In the present invention because media 210 can not only be associated with entities, but also functions within entities adjacent to a discrete land space 106, the system permits a significant degree of functionality.

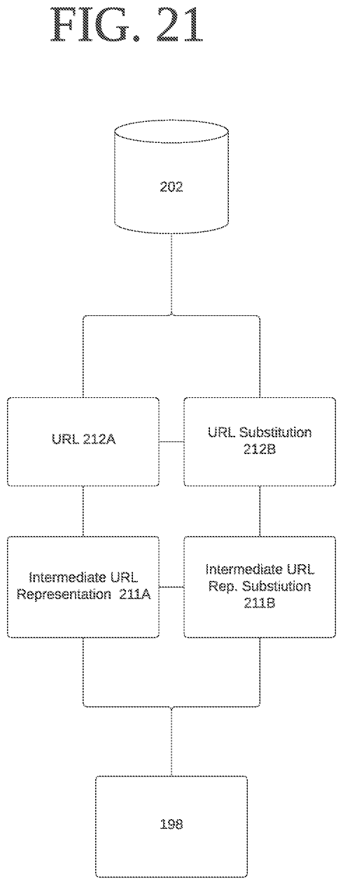

The system and process also support the transmission 150 of media files 210 from the user 900 and his mobile computer 198 to the master computer database 202. As shown in FIG. 17, the present invention can allow any information 218 and data associated with a geographic feature to be associated with a virtual node 114. These associations can be provided in any number of categories, and a feature of the present invention is to allow a virtual node to be subdivided into two components: owner data 114a and user data 114b. Owner data 114a can be sold commercially to a stakeholder of the parcel represented by the virtual node 114, such as a residence-owner or business-owner. The user data 114a can include any data that a user can supply, which can often be inflammatory, incorrect, or otherwise undesirable. Accordingly, the owner may have enhanced access rights that allow him to edit not only his information 114a, but also that provided by third parties 114b—but presumably not in the reverse. Examples of information 218 can include descriptions of one or more physical features of the node 114, ratings of the feature of the node (e.g., “best table in the restaurant”), etc. URL data 212 associated with the node can be supplied by the owner or the user. The URL data can include multiple incarnations including the direct URL data which is the Uniform Resource Locator. A URL is nothing more than the address of a given unique resource on the Web. In theory, each valid URL points to a unique resource. Such resources can be an HTML page, a CSS document, an image, etc. In practice, there are some exceptions, the most common being a URL pointing to a resource that no longer exists or that has moved. As the resource represented by the URL 212A and the URL itself are handled by the Web server, it is up to the owner of the web server to carefully manage that resource and its associated URL. A URL as determined by any regulatory authority An intermediate URL is a non-direct URL that points to a link that is intermediately static while the direct URL changes. GOOGLE, for example, uses “via this intermediate link” to mean that some sort of redirect was involved. Links that go through a redirect certainly count as back links. It isn't bad that a back link goes through an intermediate link unless the link is otherwise spammy or the redirect were a paid redirect, see e.g. FIG. 21. As shown by FIG. 21

Turning now to FIG. 9, a substantial advance of the present invention includes the capacity of users 900 to provide not only textual feedback 150 but also functional feedback/verification 150. As discussed earlier, the system can begin by accepting 120 geographic region data and parsing the same into the discrete land spaces 106, but the present invention can also include the sua sponte creation of a virtual node corresponding to a discrete land space 106, or the alteration of the virtual node to a new discrete land space 106. In other words, the system 200 can verify the accuracy of a discrete land space 106 correlated to the virtual node. The art of location determination can be derived in multiple ways, including a GPS determination, a triangulation determination based on three or more communication towers, etc; and these determinations comes with their unique bases for fault. There may be many error-based correlations between the virtual nodes and land spaces, or the virtual nodes may be logically faulty.

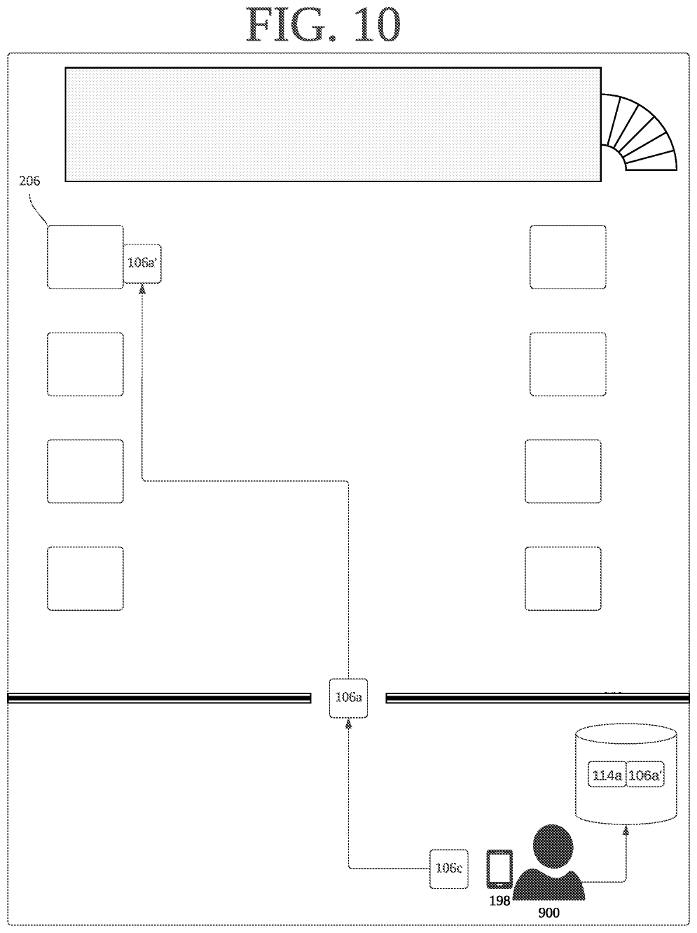

An example of verification of the system includes a user 900 with his mobile computer 198 holding the mobile computer 198 on or near the discrete land space 106 meant to be correlated to a virtual node. For example, a user may position his mobile computer 198 at the elevator of hospital. The elevator may a width that covers multiple discrete land space 106 forms, perhaps four to six of them, and the master computer may save the virtual node as comprising multiple geometric parcel forms corresponding to multiple discrete land spaces. However, initial mapping and parsing steps may be in error. The original destination, i.e. target, discrete land space may correspond to a particular virtual node, and if multiple users select that particular virtual node and user feedback indicates that the target discrete land space 106 of consequence is not where originally determined by the system and process, the present invention can alter the node-space correspondence. So in the example, of FIG. 9, an outdoor music performance, the target discrete land space 106a, here the one in front of one of the service tents, is positioned in an ambiguous spot. It is between two tents, although largely in front of one. Because the present invention has the capacity to lead a user 900 to a particular service tent, the tent sought by the user as the target may be adjusted. Doing this, the user can first proceed to the target discrete land space 106a at the bathroom entrance, and then proceed to the target discrete land space in front of the bathroom stall desired. A notice can be pushed 150 from the master computer to the user 900 and his mobile computer 198 indicating that user 900 is positioned slightly askew of where the target virtual node 114a believes the target discrete land space 106a to be. The user 900 on his mobile computer 198 can, with the activation of a single button, push 140 the actual location of the discrete land space 106a′ in front of the desired tent, which is shown in FIG. 10.

The system and process can handle this situation in multiple ways. A preferred means is to provide both alleged target discrete land spaces 106a, 106a′ to the network of users allowing them to, in turn, verify where the actual location of which target discrete land space 106a′ ought to be correlated with the target virtual node 114a may be. This decision could be on the basis of user credibility, which include length of time having used the system, prior verification accuracies, age, profession (e.g., food critics may have a superior view on the attributes of, say, a food service tent), or any other basis of credibility. The decision could be based on quantities of user verifications.

The present invention also has the capacity to make alternative virtual nodes, particularly for preferential targets. A preferential target, which is similar in spirit to a functional target, occurs when the attribute of a discrete land space is based on a comparison similarly functional features. For example, the present invention could store multiple discrete land spaces based on subjective ratings, such as “cleanest tent.” The features, here tents, could each receive a rating from users that have utilized the features and store them with associated user attributes. Exemplary user attributes can include any attribute of a person helpful to the determinative comparison of different features, such as height, weight, speed, dress, time, functionality, etc. In consideration of functionality, handicapped users may have very different opinions on the functionality of a service provider. The time at which a tent is ‘preferred’ could greatly depend on the time in which the tent is visited. In a concert scenario, the best tents fixtures could differ in the morning vs. the evening because of the food offered for sale. A preferential search 150 for food service in a service could return 140 a particular fixture discrete land space 106a at 10:00 am and a different one at 4:30 pm because one supplier may excel at breakfast, while another excels at dinner.

Another example of a functional label and the credibility could be based on safety. For example, a building may have different safety locations based on particular incidents and the degree of safety could be based on the particular emergency. Therefore, the present invention can have a series of standard defaults related to emergencies, e.g. “fire,” “tornado,” “criminal acts,” etc. The credibility for “fire” target discrete land spaces could be based on the location of fire extinguishers, hoses, fire alarms, etc. and be informed by safety professionals, such as fire department or police officers, which would have preferential credibility ratings. In the instance of tornadoes, the safety positions would be located in a building interior away from windows and doors. There could be a variety of such locations in interior spaces, and the present invention could further measure the users that are going to particular interior space locations such that an appropriate number go to particular spaces. One aspect of the present invention could be to track which users go where, and limit or otherwise inform, the next user related to another or similar space. In another embodiment of the present invention, users could be tracked, perhaps with mandatory application installs, and a region is divided into discrete land spaces, such as for a bathroom. The present invention could track which user has asked to go the bathroom and sort the users such that there is not a bathroom use ‘collision.’ In other words, the present invention could be used an efficient sorting tool where there are a limited number of users and a limited number of resources, and the system could route users to available resources. These resources could include office equipment (e.g., copiers), telephones, automobiles, food, tables, etc.

Returning to FIG. 8, the present invention could include a robust media and file system. Wherein media 210 is associated with the virtual nodes.

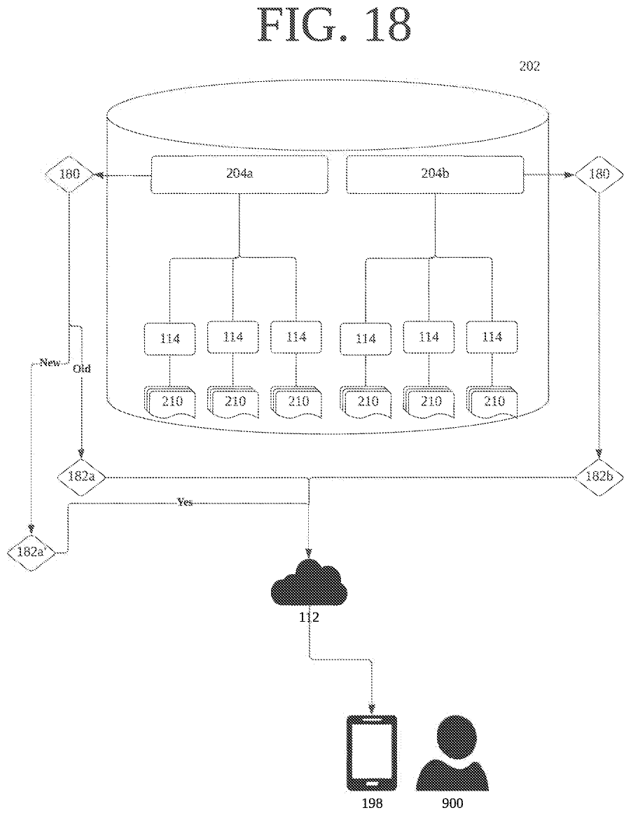

Turning now to FIG. 18, the present invention includes intermediary WAN resources 180 that lead to visible, final WAN resources 182. This hierarchical nomenclature ensures that users, particularly commercial users of the system are capable of changing WAN resources with minimal problems.

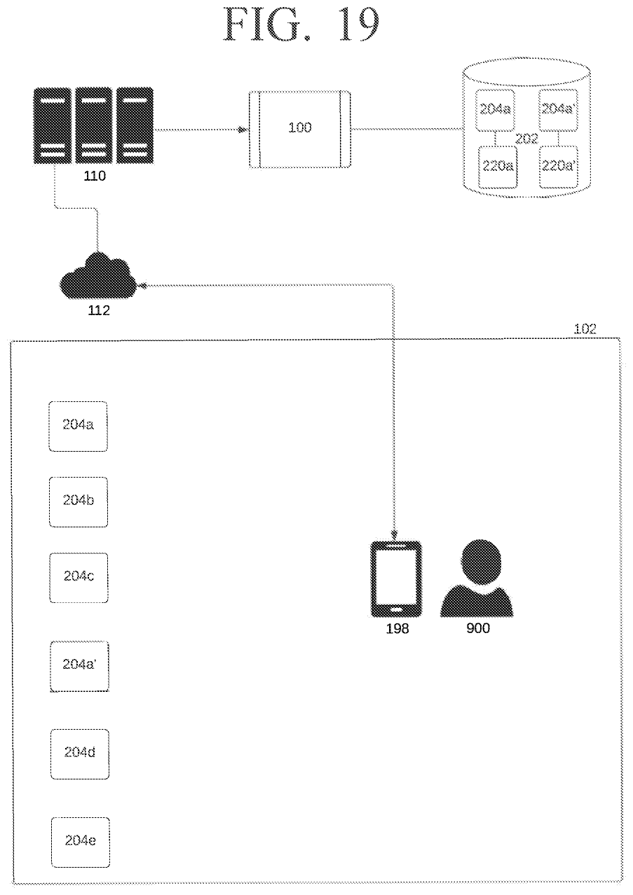

FIG. 19 demonstrates the capacity of the present invention to provide relevant advertisements to users thereof actively or passively. The system 202 is capable of storing significant amounts of information from commercial or end users, including functional attributes of the entities 204 as well as the features 206 within the entities. A user can alternate the extent to which the present invention actively or passively provides information.

In one embodiment of the present invention the system can accept 150 a query from a user concerning the location or features of a restaurant. The user 900 can input 150 such data as is important to it concerning the restaurant, i.e. entity attributes 214. The entity attributes for a restaurant may include such concepts as food types, allergen sensitivities, location, price, etc. The system 200 can scour the attribute labels organically acquired, provided 150 by a user, provided 150 by a commercial user, etc. Based on the input 150 provided by the user, the system can return 140 a series of recommendations based on the input. For example, if a user provides 150 the entity attribute “steak,” the system can review labels that include “steak” or conceptually similar thereto based on any relevant correlation engine and provide entities 204 that may be of interest to the user. The entity list may include any such other information as may be useful, such as distance, pathway, traffic, coupons, etc. Commercial versions of the present invention can attempt to sway users to favor one entity over another, particularly when an advertiser is seeking to compete with certain types of entities. For example, a user that seeks store 204a among other stores may be provided with a list of comparable stores. In particular, a user can indicate either through the entity or the discrete land space that it intends to head to a particular entity and that entity has a list of its attributes 220. If there is a cross-over of that target entities attributes and the attributes of another entity the present invention can notify the user of the overlap. For example, a user headed to an office supply store may discover that the store is closed upon his arrival, or calculated to be closed on his arrival; however, the present invention can ascertain other stores that have an entity attribute 220 overlap. The system may ask 140: “Are you seeking staples? If so, staples can be acquired at [other store].” More directly, a user could ask the system for staples, and the present invention could search the entity labels 220 to discern which entities carried staples, and provide a list of such stores, informing 140 the user that 204a is equivalent to 204a′. Similarly, a correspondence engine could equate staples with a series of other binders and notify 140 the user of the stores that may not carry staples, but do carry brad pins.

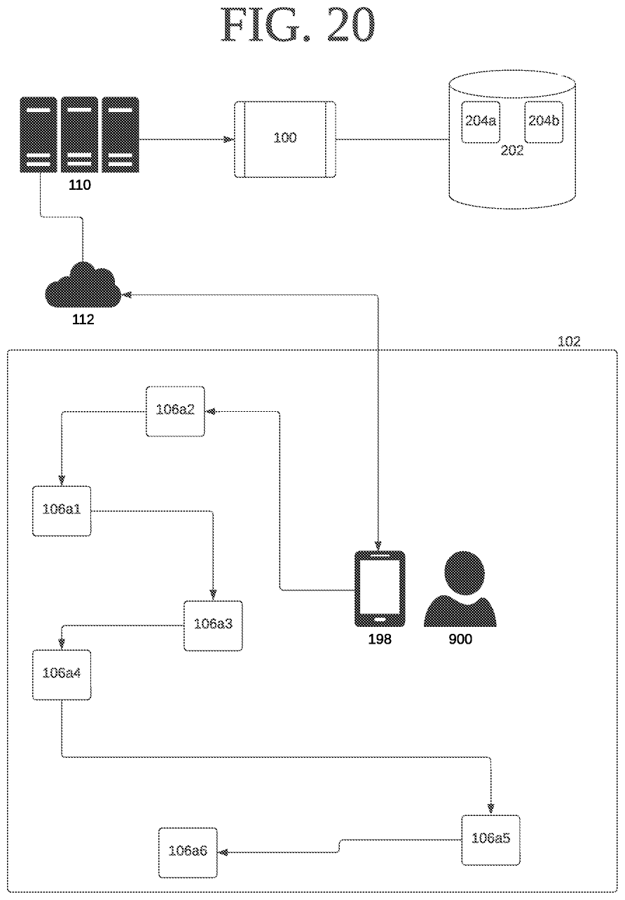

As shown in FIG. 20, the entities 204 can be people and the files and virtual nodes can relate to a person's interests. In one embodiment of the present invention, because the spaces can be such that a person can occupy the standing space that one might require for a museum piece or landmark (including from different angles), the present invention can be commentary by person-entities throughout a region 102. The target discrete land spaces 106a (1-6) can be the sequential (or other) arrangement of areas in which a user might stand to have an experience crafted by a person entity. One could stand in the discrete land space where John F. Kennedy was shot and then proceed to the book depository window from which he was allegedly shot. Then one could stand in the spot which future President Johnson stood as he took the oath to lead (read as: “ruin”) the United States as chief executive. The media files related to the discrete land spaces could be the views which were available at the time to discern the contrast between then and now, and the media files could include narration by a person of interest and the audio files concerning the discrete land spaces and the views therefrom.

Additional incoming data 150 provided by a user can include “pinging.” By pinging 252, it is meant any communication of arbitrary data that includes geolocation data of an operator with an electronic device capable of sending such geolocation data. Examples of geolocation data includes meta data providing location data as part of the communication. A ping 252 is a specific type of communication that relies on the inherent data of a communication to determine location. In particular, the present invention can utilize pinging to (i) initially generate location data for an entity or a discrete land space, (ii) edit the location data for an entity or discrete land space, (iii) calibrate the location data for an entity or discrete land space. Pinging for a discrete land space usually relates to a traveling path or a throughway. Because an entity may often comprise multiple land spaces, the entity can be altered based not only on accuracy, but also consensus of a dominant discrete land space. For example, the discrete land space of concern for a store may very well be the entryway; however, this may not always be the case. Once pinging has occurred, the present invention can alter the physical discrete land space associated with a virtual node based on any data analysis desirable. A convention means of determining the appropriate physical discrete space associated with a virtual may simply be a ‘majority’ analysis such that five pings associated with one virtual node as compared with two pings associated with another virtual node. It may be the case that even a single ping related to an attribute may disqualify that virtual space for a particular attribute. For example, if three virtual nodes are associated with an entryway, even a single ping for a location-notwithstanding that there may be, say, ten pings to the contrary—that determines that there is an obstruction may disqualify that space for being labeled an entryway since two other nodes seem perfectly serviceable.

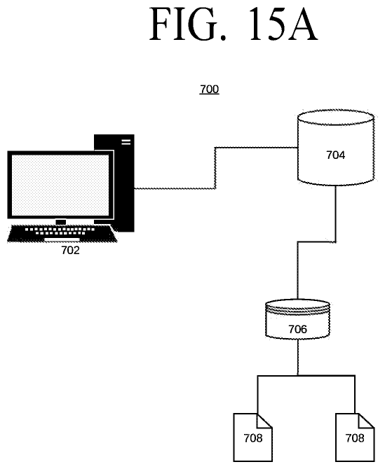

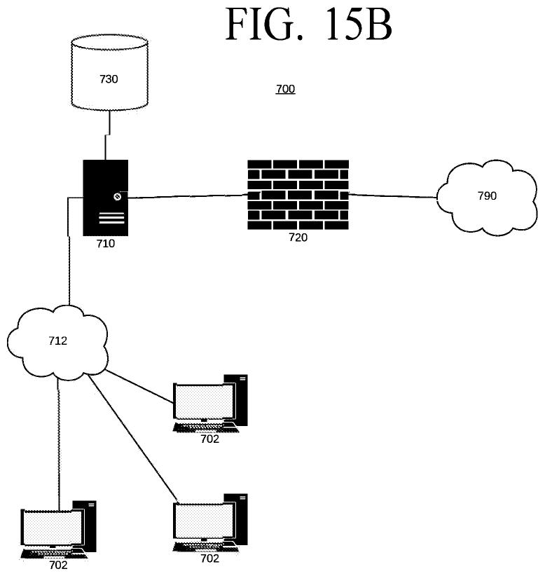

FIGS. 15A-B depict a computer ecosystem 700 of the present invention. By ecosystem it is meant one or more computers 702 that are organizationally related. The ecosystem may include computers under common ownership, computers that belong to the same network or series of networks, computers that are collaborating, etc. The present invention may be provided as a computer program product, or software that may include a computer-readable storage medium 704 having stored thereon instructions, which may be used to perform the process of the present invention across a computer ecosystem 700 according to the various embodiments disclosed herein.

A computer 702 of the present invention may include any combination of one or more computer readable media 704. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium 704 may be any tangible medium that can contain, or store a program for use by or in connection with an instruction execution system, apparatus, or device.

A computer readable signal medium 704 may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures described below illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, the functionality of one block may be subsumed by the functionality of another block as a substep thereof. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

An ecosystem 700 may further include a computer network or data network that allows computers to exchange data. In a computer network of the present invention, networked computing devices pass data to each other along data connections. The connections between nodes are established using cable media, wireless media, or other media. The Internet or other exterior network 790 may be a component of the ecosystem 700. Nodes may include hosts such as personal computers, phones, servers, and networking hardware. Two such devices are networked together when one device is able to exchange information with the other device, whether or not they have a direct connection to each other. Computer networks of the present invention support applications such as access to the World Wide Web, shared use of application and storage servers, printers, and fax machines, and use of email and instant messaging applications. Computer networks may be included irrespective of the physical media used to transmit their signals, the communications protocols to organize network traffic, the network's size, topology, and organizational intent.

It is preferred that the network of the present invention have at least one boundary 720, and potentially multiple boundaries if a demilitarized zone is utilized. The boundary 720 may include any number of layers designed to regulate and secure the flow of information between networks. Boundary layers of the present invention may include enterprise content management software, firewalls, filters, threat management software, alarms, etc. Software for establishing a boundary may be run on a server 710 with server storage 730 of the present invention, which may include directory services controlling access credentials.

To combat security risks posed by network connections, firewalls are frequently used. A firewall may be a hardware or software component that filters network traffic so that communications with unauthorized third parties are blocked but legitimate network functions may be carried out. Frequently, the filters applied by a firewall are specified by a set of policies defining characteristics of network messages that either should pass through the firewall or that should be blocked. Because different levels of communication may be appropriate depending on the origin or destination of messages, firewall policies may be provided for each application that executes on a computing device and communicates over a network.

A firewall may have an outward side facing a global network, such as the Internet. The opposite side of the firewall may be a private network that is protected by the firewall. The private network may include any number of host machines (e.g., computers) each addressable by its own IP address. The physical construction of the network may be such that all data packets intended for one of the IP addresses behind the firewall pass through the firewall. Using the firewall rules, which may be set by a network administrator or other user, the firewall may determine whether to allow or deny certain data packets and/or determine where to route particular data packets based on the IP addresses to which the packets are directed. The determination of where to route data packets may be done using the IP addresses of the host machines in the private network.

Depending on the addressing scheme used by the network, the IP addresses of the host machines may be static or dynamic. Static IP addresses do not change over time, and thus once they are set in the firewall rules, there is no need to update them. The Internet Protocol version Four (IPv4) addressing system commonly uses static addressing, while IPv6 may use dynamic addressing. Dynamic IP addresses may change over time and thus, there is a need to update the firewall rules as changes occur. When a small Local Area Network (LAN), such as a domestic network in a private residence, is linked to a larger network such as the Internet, the link is often through a gateway router acting as a firewall. One of the functions of the firewall is to protect the LAN from intrusion from outside.

A service directory accessible by a server 710, usually on server storage 730, stores information about network resources across a domain. An example of a directory service is Active Directory. The main purpose of Active Directory is to provide central authentication and authorization services for Windows-based computers. Active Directory also allows administrators to assign policies, deploy software, and apply critical updates to an organization. Active Directory stores information and settings in a central database.

An Active Directory structure is a hierarchical framework of objects. The objects fall into three broad categories: resources (e.g. printers), services (e.g. e-mail) and users (e.g., user accounts and groups). The Active Directory provides information on the objects, organizes the objects, controls access and sets security. Certain objects can also be containers of other objects. An object is uniquely identified by its name and has a set of attributes—the characteristics and information that the object can contain—defined by a schema, which also determines the kind of objects that can be stored in the Active Directory.

Typically, the highest object in the hierarchy is the domain. The domain can be further subdivided into containers called Organizational Units. Organizational units give a semblance of structure to the organization either based on administrative structure or geographical structure. The organizational unit is the common level at which to apply group policies, which are Active Directory objects themselves called Group Policy Objects. Policies can also be applied to individual objects or attributes as well as at the site level (i.e., one or more IP subnets).

The present invention may use one of more communication networks to foster information exchange throughout the computers of the ecosystem. Communication networks might either be private or public. In a private network, communications between multiple computers occur in a secure environment that prevents access from outside the network without appropriate authentication. These networks are considered as “trusted” networks because the communication signals securely travel from one computer to another within the private network without being exposed to the external environment.

Public networks such as the Internet, on the other hand, are not secure because the communication over these networks is not private and is susceptible to interception by other computers. In addition, the public networks cannot guarantee the delivery of the data packets being sent. They allow packets to be injected into, or ejected out of, the networks indiscriminately, and analyzed while in transit. To keep data sent over a public network private, a Virtual Private Network (VPN) is commonly established on top of a public network when two computers use the public network to communicate with each other. In a Virtual Private Network, data sent from one computer to another is encrypted by a security gateway and transmitted in encrypted form over the public network to a second security gateway connected to the receiving computer. The second gateway decrypts the data before forwarding it to the receiving computer. Such a private channel established on top of another network is referred to as a network tunnel.

In order to set up a Virtual Private Network, a user first establishes a path to a VPN server and goes through an AAA process (Authentication, Authorization and Accounting) for identification and authorization to create a secure tunnel with the server. Once the user is authorized, a secure network tunnel is established between the user and the VPN server over the public network, using a VPN protocol such as IPsec. This process requires a VPN client on the user's side, a VPN server and other VPN hardware on the other side of the tunnel, as well as appropriate user configurations.

Present day private networks often include wireless networks such as WiMAX to accommodate mobile access. In addition, to provide mobility access in a large geographic area, a private enterprise often relies on third-party wireless infrastructures besides its own wireless network. In this case, a user's device would need to be authenticated by both a third-party gateway and an enterprise authentication server before it could access the enterprise network. User credentials are typically requested by and securely returned to the third-party gateway. Once the user is authenticated and authorized, the user may communicate with the third-party wireless gateway.

The present invention includes files 708, which may include executable instructions by which the present invention runs, or files upon and with which the present invention interacts. The documents may be on local storage 704 or shared storage 730 and be created, accessed, edited, and/or otherwise modified using any of a number of applications, including for example and without limitation Final Cut Pro, Avid, Microsoft Office applications (Word, Excel, Power Point, Outlook, Visio, etc.), Adobe Reader or Acrobat, AutoCAD, SolidWorks, or any other suitable document editing application. The content of the documents may be audio tracks, video clips, images, word processing documents, presentations, spreadsheets, business documents, engineering documents, databases, etc.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

### INDUSTRIAL APPLICABILITY

The present invention includes a system and process for geolocation. Rather than rely on attempted precision measurements concerning physical spaces, the present invention utilizes a space filling curve that maximizes calculation concerning both correlation ability and efficiency. Physical space is associated with virtual nodes standing in as approximations, and these nodes can be assigned various attributes describing them. The virtual nodes, although by nature less precise, are sized nevertheless to permit a narrow or even individual space for a user to be positioned.

What is claimed is:

1. A location process comprising:
rendering in a master computer a digital representation of a physical geographic region as a virtual land domain;
parsing said virtual land domain into a myriad of virtual nodes extending from a center of plot points of a space-filling curve occupying said virtual land domain, said plot points characterized by a decimal representation comprising at least six decimal places, wherein said virtual nodes correspond to a subdivision of said physical geographic region into a series of discrete land spaces; and
broadcasting through a Wide Area Network (WAN) a request of said virtual node to a mobile computing device of a user querying a location of said geographic region.

2. The process of claim 1 further comprising converting said decimal representation to a sexagesimal degree representation for correlation with said decimal representation.

3. The process of claim 2 further comprising a database correlating at least one of said geometric forms as a sexagesimal degree representation geohash.

4. The process of claim 3 further comprising the step of accepting data input from said user and correlating said data input with said decimal representation.

5. The process of claim 4 wherein the step of accepting data input includes accepting a digital file input from said user and correlating said data input with said decimal representation.

6. The process of claim 5 wherein said user is correlated with said digital file input.

7. The process of claim 4 wherein said user is correlated with said data input.

8. A location process comprising:
storing in a master computer a digital representation of a physical geographic region as a virtual land domain having parsed said virtual land domain into a myriad of virtual nodes extending from a center of plot points of a space-filling curve occupying said virtual land domain, said plot points characterized by a decimal representation comprising at least six decimal places, wherein said virtual nodes correspond to a subdivision of said physical geographic region into a series of discrete physical land spaces;
identifying via a Wide Area Network (WAN) broadcast a target virtual node correlated to a desired physical land space;
approximating a starting point virtual node correlated to a starting point physical land space;
communicating between said master computer and a mobile device of a user a course pathway composed of multiple virtual nodes from said starting point virtual node to said target virtual node.

9. The process of claim 8 wherein said communicating step further includes communicating a course pathway, including a distance estimation between said starting point physical land space and said target discrete land space based on a virtual nodes corresponding to said starting point discrete land space and said target discrete land space.

10. The process of claim 9 wherein said course data includes a pathway estimation.

11. The process of claim 9 wherein said virtual nodes include attributes indicating (i) obstruction and (ii) entryway, and said course data excludes virtual nodes correlated to corresponding to known obstructions.

12. The process of claim 11 wherein said ‘entryway’ attribute includes a variable data correlating to a circumstance.

13. The process of claim 11 wherein said course data includes saud pathway estimation that excludes virtual nodes corresponding to obstructions.

14. The process of claim 13 wherein said course data includes said pathway estimation calculated based upon ‘passable’ nodes.

15. A location process comprising:
storing in a master computer a digital representation of a geographic region as a virtual land domain having parsed said virtual land domain into a myriad of virtual nodes characterized by a decimal representation comprising at least six decimal places adapted to define said virtual land to a discrete surface area having a square root of less than an average shoe size for said geographic region;
broadcasting through a Wide Area Network (WAN) a request of a mobile computing device of a user querying a target discrete land space correlated to a target virtual node correlated to said target discrete land space; and
transmitting a verification ping from said mobile computer juxtaposing said target virtual node to said target discrete land space based on said discrete parcel geometric.

16. The process of claim 15 wherein said target virtual node is substituted by a verified virtual node different from said target virtual node.

17. The process of claim 15 wherein said target virtual node is based on a calculation of multiple candidate target virtual nodes and said target virtual node is chosen statistically.

18. The process of claim 15 wherein said virtual nodes include attributes indicating (i) obstruction and (ii) entryway.

19. The process of claim 18 wherein said virtual node selects from among multiple candidate virtual nodes indicating obstruction to apply said obstruction attribute statistically to at least one of said candidate virtual nodes.
